(19) United States
(12) Patent Application Publication
(10) Pub. No.: US 2014/0239879 A1
(43) Pub. Date: Aug. 28, 2014

(54) BATTERY CHARGING SYSTEM

(71) Applicant: ELECTRO-MOTIVE DIESEL, INC., LaGrange, IL (US)

(72) Inventor: John Ernst Nielsen Madsen, Lemont, IL (US)

(73) Assignee: Electro-Motive Diesel, Inc., LaGrange, IL (US)

(21) Appl. No.: 13/774,061

(22) Filed: Feb. 22, 2013

(51) Int. Cl. H02J 7/00

(52) U.S. Cl. CPC H02J 7/0054
USPC 320/104

(57) ABSTRACT

A charging system for a traction battery is disclosed. The charging system includes a power grid, a stationary battery, a first controlled power supply, a second controlled power supply, and a switching unit. The first controlled power supply is configured to provide electrical power from the power grid to the stationary battery, at a first controlled rate. The second controlled power supply is configured to provide electrical power from the stationary battery to a traction battery, at a second controlled rate, higher than the first controlled rate.

### TECHNICAL FIELD

The present disclosure relates to a battery charging system and more particularly, to a battery charging system for charging a traction battery.

### BACKGROUND

Conventional electric vehicles, such as electric locomotives are powered by a direct current (DC) battery system. For example, an electric vehicle may have a DC battery system for driving a plurality of locomotive bogies. The DC battery system may include one or more DC batteries such that the one or more DC batteries are charged using a commercial power electric grid. Further, a recharge point or station may also be employed for charging the one or more DC batteries.

For example, U.S. published application 2008/0277173 (the '173 application) describes one such system. The '173 application relates to a recharging station for charging an electric vehicle powered by energy storage means. The electric vehicle follows a route via a point at which the recharge station is located. The recharge station comprises a recharging means that includes a storage device for storing electrical energy delivered by an electrical energy source. The recharging means further comprises a connection means for electrically connecting the storage device to a storage means of the electric vehicle for transferring electrical energy of the recharge station to the storage means of the electric vehicle.

In present cases of increased number of electric vehicles, typical recharge systems are unable to meet large energy demands for sufficiently charging these electric vehicles. The present disclosure is directed to overcome one or more of the problems as set forth above.

### SUMMARY

In one aspect, the present disclosure provides a charging system for a traction battery. The charging system includes a power grid, a stationary battery, a first controlled power supply, a second controlled power supply, and a switching unit. The first controlled power supply is configured to provide electrical power from a power grid to the stationary battery, at a first controlled rate. The second controlled power supply is configured to provide electrical power from the stationary battery to a traction battery, at a second controlled rate. The switching unit is configured to form one of a first closed circuit for charging the stationary battery at the first controlled rate and a second closed circuit for charging the traction battery at the second controlled rate. The first closed circuit includes the stationary battery, the first controlled power supply and the power grid. The second closed circuit includes the traction battery, the stationary battery, and the second controlled power supply.

In another aspect, the present disclosure provides a locomotive having a traction battery and a power connection unit for coupling the traction battery to a charging station. The charging station includes a power grid and a stationary battery. The locomotive further includes a control unit to monitor a remaining energy in the traction battery and a location of the locomotive with respect to the charging station. The control unit further communicates a signal to the charging station to disconnect a first closed circuit, which provides a charging connection between the power grid and the stationary battery. The signal is indicative of an arrival of the locomotive at the charging station and a charging requirement of the traction battery. The control unit further actuates the power connection unit to engage the charging station to establish a second closed circuit to charge the traction battery at a second controlled rate from the stationary battery.

Other features and aspects of this disclosure will be apparent from the following description and the accompanying drawings.

### BRIEF DESCRIPTION OF THE DRAWINGS

FIG. 1 illustrates a battery powered locomotive at a charging station, in accordance with an embodiment of the present disclosure;

FIG. 2 illustrates a schematic diagram of a charging system for a traction battery, in accordance with an embodiment of the present disclosure;

FIG. 3 illustrates a detailed schematic diagram of the charging system with a first closed circuit, in accordance with an embodiment of the present disclosure;

FIG. 4 illustrates a detailed schematic diagram of the charging system with a second closed circuit, in accordance with the embodiment of FIG. 3;

FIG. 5 illustrates a detailed schematic diagram of the charging system, in accordance with another embodiment of the present disclosure; and

FIG. 6 illustrates a process flow of charging the traction battery, in accordance with an embodiment of the present disclosure.

### DETAILED DESCRIPTION

The present disclosure relates to a traction battery charging system for charging a traction battery of electric vehicles, such as, but not limited to, battery powered locomotives, mining trucks, highway trucks, buses, passenger cars, or the like. Charging may be broadly defined as storing energy in any energy storage unit. For example, charging may include storing electrical energy in the form of chemical energy in an electrochemical battery. Examples of the energy storage unit may include, without limitation, cells, batteries, and the like.

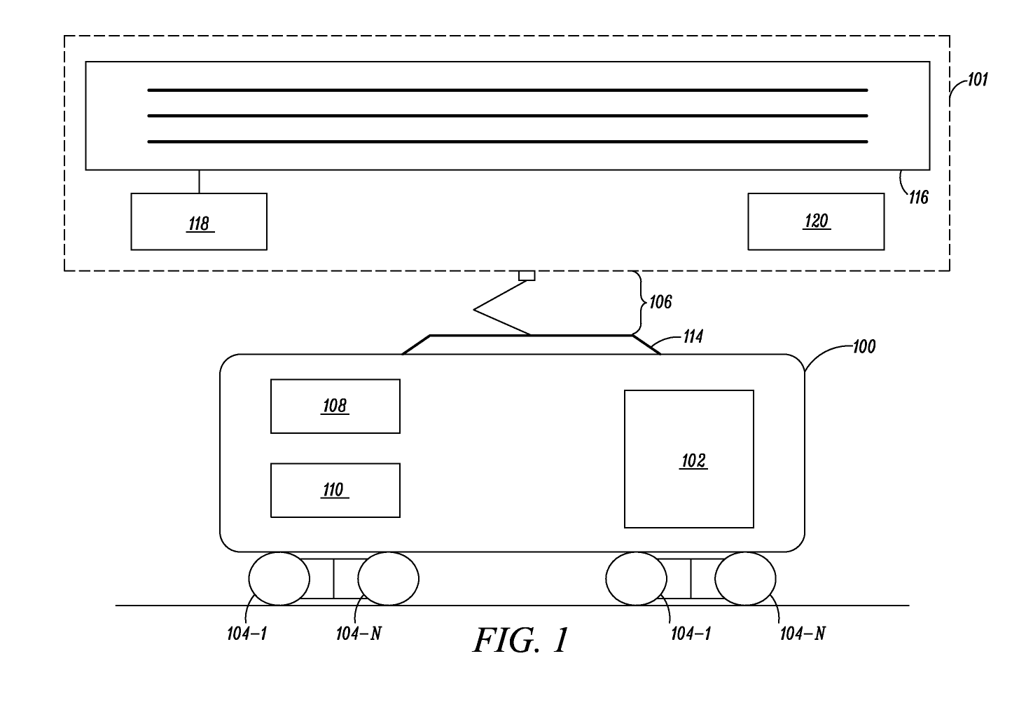

FIG. 1 illustrates a battery powered locomotive 100 (hereinafter referred to as ‘the locomotive 100’), at a charging station 101 in accordance with an embodiment of the present disclosure. The locomotive 100 includes a traction battery 102, N electric traction units 104-1 to 104-N, a power connection unit 106, a power system 108, and a control unit 110. In various embodiments, N may be any integral number more than or equal to 1 depending on the traction requirements of the locomotive 100. The electric traction units 104-1 to 104-N may be AC or DC traction units within the scope of the present invention. Each of the electric traction units 104-1 to 104-N may include one or more electric motors, wheels driven by the one or more electric motors, and a suspension. Further, a transmission may be provided between the electric motors and the wheels. A braking system may also be provided in each of the electric traction units 104-1 to 104-N. Alternatively, a common braking system may be utilized for the electric traction units 104-1 to 104-N. The braking system may include, for example, but not limited to, regenerative braking, dynamic braking, electromagnetic braking, or the like.

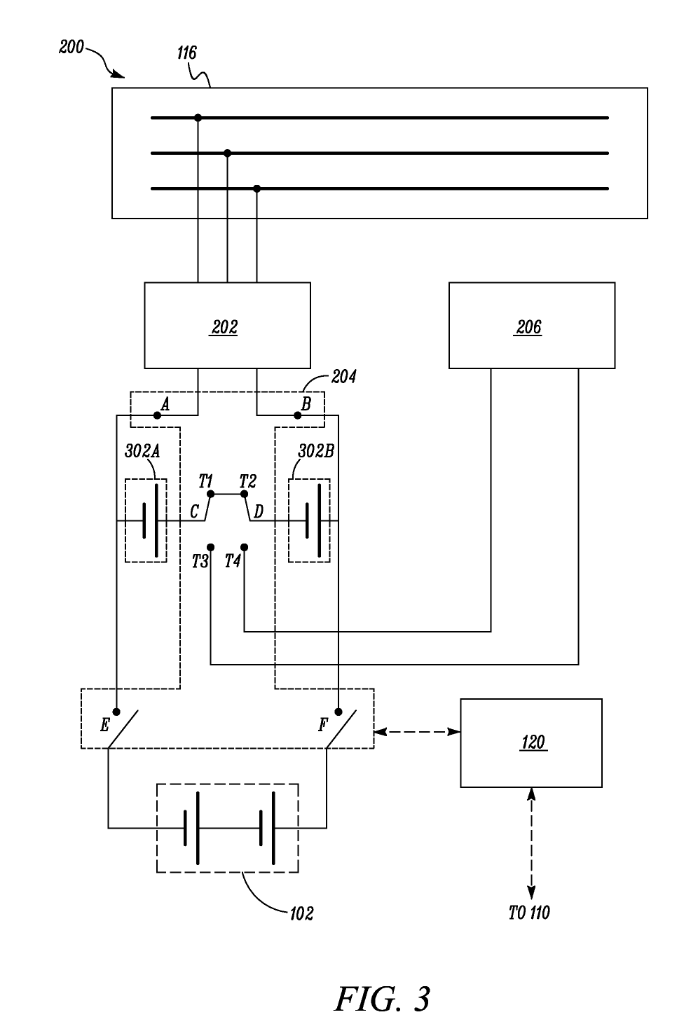

The traction battery 102 includes one or more rechargeable electrochemical cells (not shown) or battery units (as shown and described in detail with reference to FIGS. 3-5) for powering the locomotive 100. Examples of the traction battery 102 may include, without limitation, lithium-ion batteries, nickel-cadmium batteries, lead-acid batteries, or the like. In an embodiment, the traction battery 102 of the locomotive 100 includes a plurality of lithium-ion cells electrically connected in a suitable series and/or parallel connection, based on voltage and current required to drive the electric traction units 104-1 to 104-N. The traction battery 102 powers the one or more electric traction units 104-1 to 104-N.

Further, the traction battery 102 is electrically coupled to the power system 108. The power system 108 includes one or more electrical components for controlling flow of electrical energy to and from the traction battery 102. The power system 108 may process and distribute the electrical energy from the traction battery 102 to the various electric traction units 104-1 to 104-N. The power system 108 may also include electrical components for charging the traction battery 102 at the charging station 101. In various embodiments, the power system 108 may include various power conversion units (for example, rectifiers, inverters, voltage converters, voltage regulators etc.), switching units, cut-offs, or the like. The power system 108 may also include induction braking circuits, load regulators, speed controls etc.

The traction battery 102 of the locomotive 100 is periodically charged for smooth and uninterrupted operation of the locomotive 100. The traction battery 102 is charged through the power connection unit 106. In an exemplary embodiment, as illustrated in FIG. 1, the power connection unit 106 may include a pantograph and a contact shoe. The power connection unit 106 selectively couples the traction battery 102 to the charging station 101. However, other types of power connection units may also be used in place of the pantograph and the contact shoe within the scope of the present invention. Examples of power connection units 106 include a contact shoe for a third power rail, a power receptacle for receiving a power cable, an induction power connector for receiving an induction power connector, and so forth. Further, as illustrated in FIG. 1, the power connection unit 106 is electrically connected to a protection unit 114 to protect the locomotive 100 from electrical shocks, overvoltage, short circuits, grid failure, lightning strikes, and so forth, during recharging of the traction battery 102. The protection unit 114 may include one or more circuit breakers or circuit interrupters, for example, trip circuit breakers, magnetic circuit breakers, high voltage (HV) circuit breakers, surge arrestors, and so forth.

Further, the control unit 110 is configured to control various aspects of the locomotive 100. The control unit 110 may include one or more microprocessors, a memory, I/O ports etc. Further, the control unit 110 may be connected to various sensors and sub-systems within the locomotive 100. In various embodiments, the control unit 110 monitors electrical parameters of the traction battery 102, such as, remaining energy of the traction battery 102 discharge rate, voltage, and so forth. The control unit 110 may also have stored therein information regarding the route of the locomotive 100, such as, scheduled recharging halts, distances between the scheduled recharging halts, estimated power consumption between each of the scheduled recharging halts, and so forth. The control unit 110 may utilize such information to control the charging of the traction battery 102. For example, if the remaining energy of the traction battery 102 falls below the estimated energy required for travelling to the next charging station 101, the control unit 110 may initiate a charging cycle at the present charging station 101. Further the control unit 110 may ensure that the traction battery 102 is not discharged below a preset minimum energy level to prevent deep discharge of the traction battery 102. Moreover, the control unit 110 may also control the power connection unit 106. In an embodiment, the control unit 100 may actuate the pantograph and make contact with the charging station 101, and lowering the pantograph when the traction battery 102 is charged to a desired energy level. The control unit 110 may also be configured to only actuate the power connection unit 106 when the location of the locomotive 100 is within a predefined distance from the charging station 101.

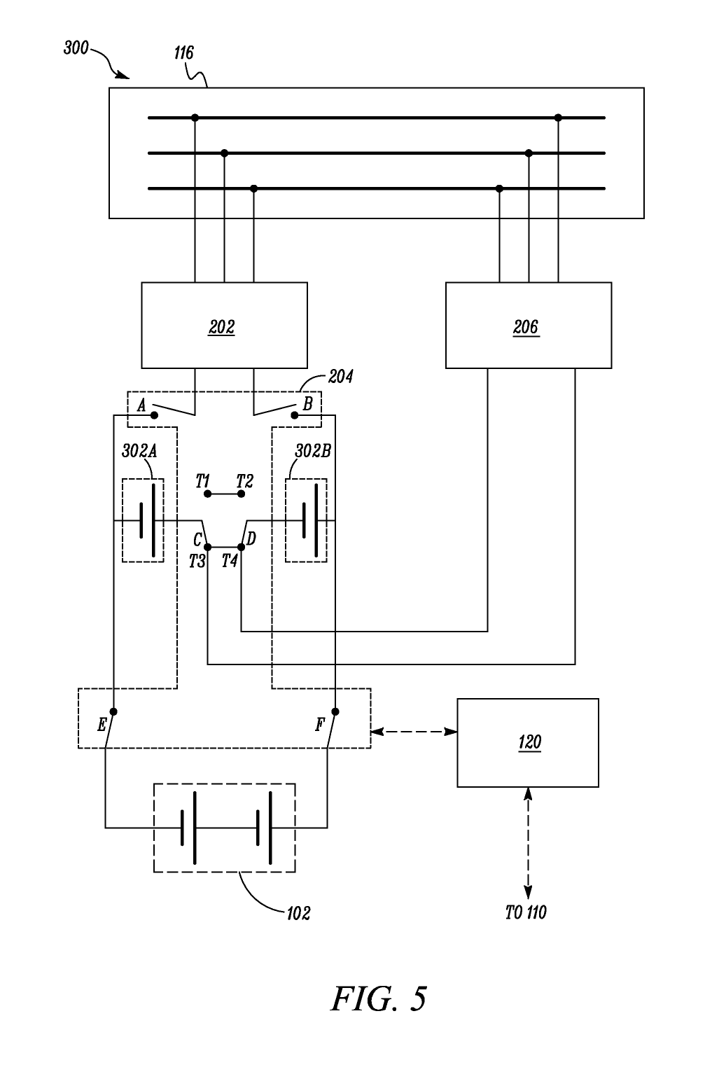

In an embodiment, as shown in FIG. 1, the charging station 101 includes a power grid 116, a stationary battery 118, and a charging controller 120. The power grid 116 may be any commercial power supply, for example, using an alternating current 3-phase 230 V transmission line. Further, in an embodiment, the stationary battery 118 selectively charges the traction battery 102 via the power connection unit 106. In another embodiment, electrical energy from the stationary battery 118 and the power grid 116 simultaneously charges the traction battery 102 (described in detail with reference to FIG. 5). In various embodiments, the charging station 101 may be provided with an overhead catenary system which includes, but not limited to, a catenary wire, one or more droppers and the contact wire. The contact wire feeds electric energy from the stationary battery 118 and/or the power grid 116 to the power connection unit 106. Although the charging station 101 is described above with reference to the overhead catenary system, other types of charging systems may be used, for example, third rail systems, inductive coupling systems, or the like, without deviating from the spirit and scope of the present invention.

The present disclosure is described with respect to a single charging station 101, however in various alternate embodiments, more than one charging stations 101 may be located at pre-defined locations along the rail route. Multiple charging stations 101 may enable the traction battery 102 to be charged after pre-defined time intervals. The charging stations 101 may be set up at distances such that the locomotive 100 is smoothly operated without undesired halts. The location of the charging stations 101 may be based on one or more factors, such as, route of the locomotive 100, distance between stop points of the locomotive 100, geographical terrain, and the like. The location of the charging stations 101 may also be based upon power and discharge ratings of the traction battery 102. The locomotive 100 may be halted within a pre-defined distance from the charging station 101, when the traction battery 102 requires charging.

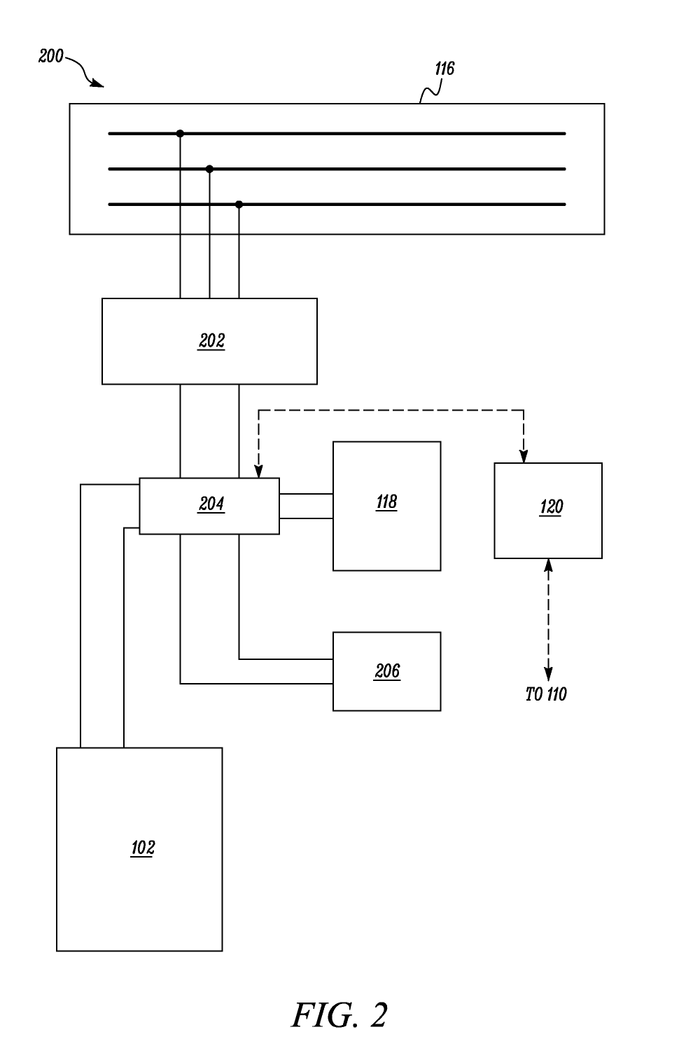

In an embodiment, the charging controller 120 may include one or more microprocessors, a memory, I/O ports, and so forth. Further, the charging controller 120 may be communicably coupled to various sub-systems of the charging station 101. The charging controller 120 controls the charging and discharging of the stationary battery 118 via one or more electrical components (described in detail with reference to FIGS. 2-5).

In an embodiment, the control unit 110 may also be configured to communicate with the charging controller 120 for charging the traction battery 102. The control unit 110 may transmit a message indicating the traction battery 102 needs to be charged. The control unit 110 may transmit the message to the charging station 101, based on, but not limited to, the remaining energy in the traction battery 102, the location of the locomotive 100 with respect to the charging station 101, and so forth. The control unit 110 and the charging controller 120 may communicate wirelessly by any of the wireless communication systems known in the art. The wireless communication between the charging controller 120 and the control unit 110 may facilitate the charging of the traction battery 102 from the stationary battery 118 and/or the power grid 116 when the locomotive 100 halts at the charging station 101.

Various components of the charging station 101 form a charging system for the traction battery 102 which will be described henceforth in details.

FIG. 2 illustrates a schematic diagram of a charging system 200 for charging the traction battery 102, according to one embodiment of the present disclosure. The charging system 200 includes the stationary battery 118, a first controlled power supply 202, a switching unit 204, a second controlled power supply 206, and the charging controller 120. The traction battery charging system 200 is electrically coupled to the power grid 116.

In an embodiment, the traction battery 102 is charged by the stationary battery 118. For charging the traction battery 102, the stationary battery 118 is first charged using the power grid 116. During charging of the traction battery 102, the stationary battery 118 is disconnected from the power grid 116 when the locomotive 100 halts at the charging station 101. Subsequently, as illustrated in FIG. 2, the traction battery 102 is connected to the stationary battery 118 such that the stationary battery 118 charges the traction battery 102.

In an embodiment, the stationary battery 118 may be a battery having same voltage and power ratings as that of the traction battery 102. The first controlled power supply 202 may include at least one first controlled power conversion unit (for example, a first controlled rectifier) and a first DC power supply (not shown). The first controlled power supply 202 is configured to provide electrical energy from the power grid 116 to charge the stationary battery 118 at a first controlled rate. The first controlled rate may be chosen such that the stationary battery 118 is charged at a slow rate over an extended period of time. The first controlled rate is advantageously chosen such that the stationary battery 118 is charged from the power grid 116 while not placing a high load on the power grid 116, thereby reducing the peak power drawn from the power grid 116.

The second controlled power supply 206 may include at least one second controlled rectifier, a second controlled DC power supply, and at least one of a voltage converter and a voltage regulator (not shown). The second controlled power supply 206 is configured to provide electrical energy from the stationary battery 118 to charge the traction battery 102 at a second controlled rate. The second controlled rate may be chosen such that the traction battery 102 is charged at a rapid rate over a short duration of time. Typically, the second controlled rate is higher than the first controlled rate. The second controlled rate may however still be chosen to not exceed a preset level, thereby preventing any damage to the stationary battery 118. The second controlled rate may also be advantageously chosen such that the traction battery 102 is charged at lower than a preset charging rate. The switching unit 204 includes switches and contact terminals for connecting and disconnecting one or more electrical components (described in detail with reference to FIG. 3) within the charging system 200. The switching unit 204 is configured to form a closed circuit based on whether the stationary battery 118 is being charged from the power grid 116, or whether the traction battery 102 is being charged from the stationary battery 118. The switching unit 204 forms a first closed circuit for charging the stationary battery 118, the first closed circuit including the stationary battery 118, the first controlled power supply 202, and the power grid 116. The switching unit 204 alternately forms a second closed circuit for charging the traction battery 102, the second closed circuit including the stationary battery 118, the second controlled power supply 206 and the traction battery 102.

The charging controller 120 may control the switching unit 204 for realizing the first or the second closed circuits for charging the stationary battery 118 or the traction battery 102, respectively. The charging controller 120 may transmit command signals to the switching unit 204, to form the first closed circuit, or the second closed circuit. The charging controller 120 is also communicatively coupled to the control unit 110 of the locomotive 100. The charging controller 120 may receive a message including parameters such as the remaining energy of the traction battery 102, the distance to the next charging station 101 on the route of the locomotive 100, an indication that the traction battery 102 requires charging, location of the locomotive 100 with respect to the charging station 101, or the like, from the control unit 110. Based on the received message, the charging controller 120 may disconnect the stationary battery 118 from the power grid 116, and connect the stationary battery 118 to the traction battery 102 for charging the traction battery 102, when the locomotive 100 halts at the charging station 101. In addition to the received parameters, the charging controller 120 may also control the switching unit 204 based on other parameters, such as, the remaining energy in the stationary battery 118 or an indication whether the power connection unit 106 is electrically connected to the charging system 200. For example, the charging controller 120 may only permit the connection of the stationary battery 118 to the traction battery 102 as long as the voltage or remaining energy of the stationary battery 118 remains above a preset safe level. The charging controller 120 may thus advantageously prevent deep discharge of the stationary battery 118, and thus prolong the operational life of the stationary battery 118. It may be possible that the switching unit 204 alternates between the first closed circuit and the second closed circuit one or more times during a single halt of the locomotive 100 based on various parameters of the stationary battery 118.

FIG. 3 illustrates a detailed schematic diagram of the charging system 200 for charging the traction battery 102, according to another embodiment of the present disclosure. The stationary battery 118 is embodied as stationary battery units 302A and 302B.

In an embodiment, as illustrated in FIG. 3, the switching unit 204 includes switches A, B, C, D, E, and F; and contact terminals T1, T2, T3, and T4, for forming one of the two closed circuits: the first closed circuit for charging the stationary battery 118, or the second closed circuit for charging the traction battery 102.

As illustrated in FIG. 3, the switching unit 204 forms the first closed circuit. In an embodiment, the charging controller 120 may be communicably coupled with the switching unit 204 and actuates the switching unit 204 to form the first closed circuit. For charging the stationary battery 118, the first closed circuit is formed as follows: the switches A and B are closed to electrically connect the first controlled power supply 202 to the stationary battery units 302A and 302B; and the switches C and D are connected to the contact terminals T1 and T2 to place stationary batteries 302A and 302B in a series connection. The switches E and F are opened to disconnect traction battery charging connectors, such as the overhead catenary system from the electrical circuit. The first closed circuit thus charges the stationary battery units 302A and 302B at the first controlled rate.

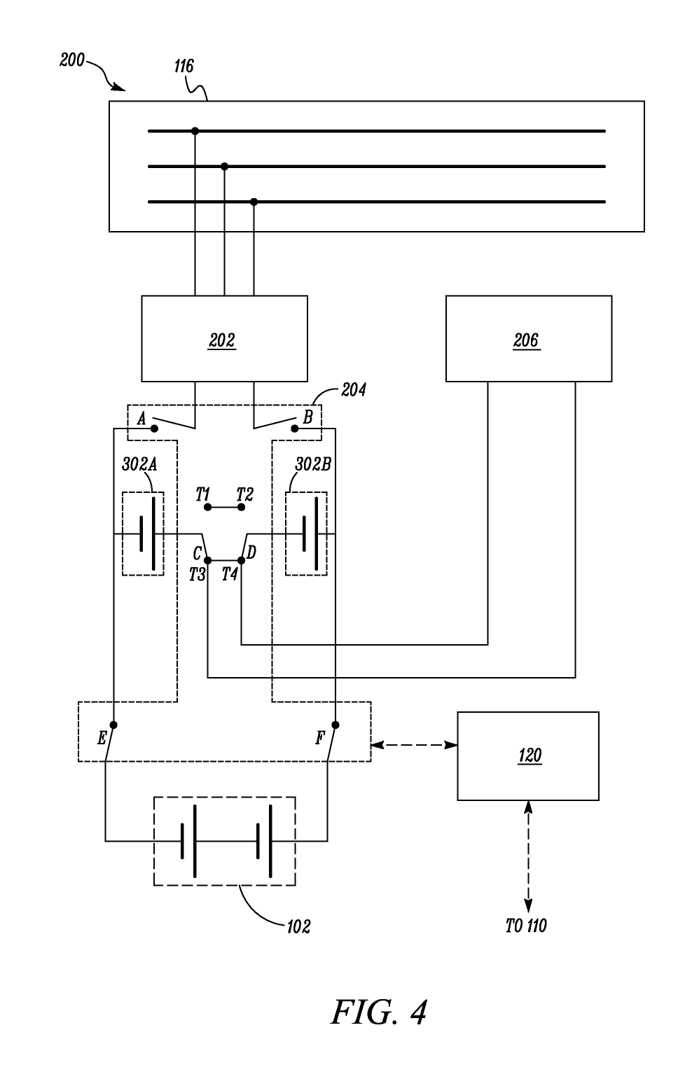

FIG. 4 illustrates a detailed schematic diagram of the charging system 200 with the switching unit 204 forming the second closed circuit. In an embodiment, the control unit 110 of the locomotive 100 may communicate a signal to the charging controller 120. The signal may be indicative of a charging requirement of the traction battery 102. Subsequently, the charging controller 120 may actuate the switching unit 204 to form the second closed circuit. The control unit 110 may also actuate the power connection unit 106 to electrically connect with the charging system 200. The power system 108 may also be provided between the power connection unit 106 and the traction battery 102 in order to regulate the charging process. The traction battery 102 is thus connected to the charging system 200 for charging when the locomotive 100 arrives at the charging station 101. For charging the traction battery 102, the second closed circuit is formed as follows: the switches A and B are opened to electrically disconnect the stationary battery units 302A and 302B from the first controlled power supply 202; the switches C and D are moved to the contact terminals T3 and T4 respectively, to place the stationary battery units 302A and 302B in series with the second controlled power supply 206; and the switches E and F are closed to connect the traction battery 102 to the stationary battery units 302A and 302B. The second closed circuit thus charges the traction battery 102 at the second controlled rate.

FIG. 5 illustrates a schematic diagram of a charging system 300 illustrating the second closed circuit charging the traction battery 102 simultaneously from the stationary battery 118 (shown as stationary battery units 302A and 302B) and the power grid 116. As illustrated in FIG. 5, the second controlled power supply 206 is electrically connected to the power grid 116. The configuration of the switching unit 204 is similar to the one described above with reference to FIG. 4. The second closed circuit charges the traction battery 102 at a third controlled rate simultaneously from the stationary battery units 302A and 302B, and the power grid 116. In an embodiment, the third controlled rate is faster than the first controlled rate. In various embodiments, the power grid 116 may be disconnected intermittently from the second closed circuit in order to reduce the peak power draw from the power grid 116, or to safeguard the various electrical components of the charging system 300 against electric surges.

### INDUSTRIAL APPLICABILITY

Charging station 101 may be used for charging and recharging of one or more traction batteries 102 of the locomotive 100. The traction battery 102 may be a lithium ion battery having a rapid recharge characteristic. The stationary battery 118, essentially of the same type and ratings of the traction battery 102 is charged from the power grid 116. When the locomotive 100 reaches the charging station 101, the stationary battery 118, disconnects from power grid 116 and then recharges the traction battery 102. In certain instances, the power grid 116 and the stationary battery 118 may simultaneously recharge the traction battery 102. The charging station 101 provides benefits of faster recharge of traction batteries 102, lesser load demands on power grids 116, lesser operation costs, and the like.

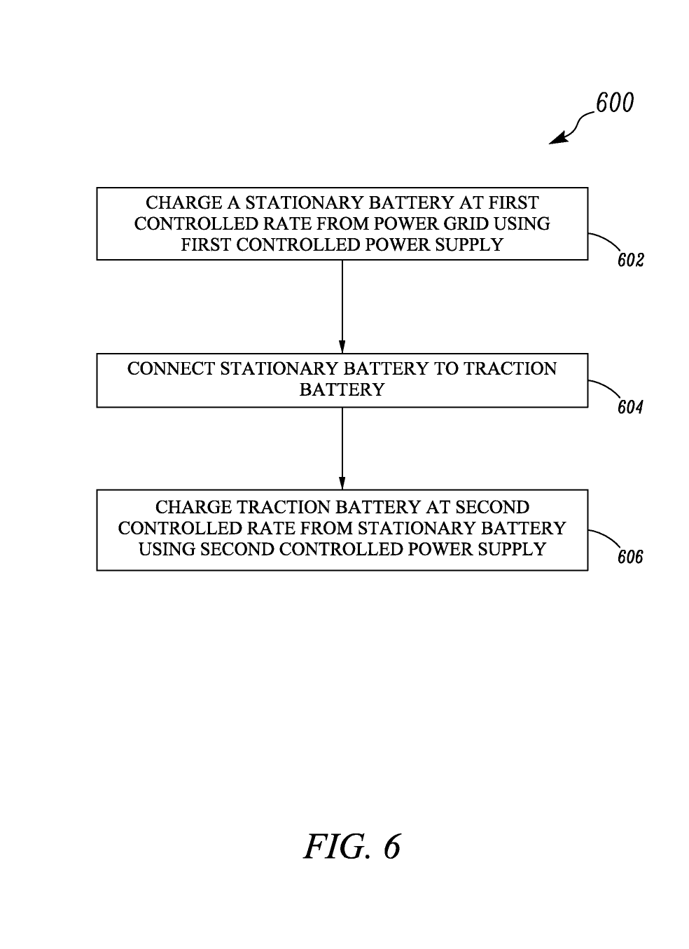

FIG. 6 illustrates an example process flow 600 for charging the traction battery 102, according to one embodiment of the present disclosure.

At step 602, stationary battery 118 is charged at a first controlled rate from the power grid 116 using the first controlled power supply 202. The first controlled rate may be chosen such that the stationary battery 118 is charged at a slow rate over an extended period of time. The first controlled rate is advantageously chosen such that the stationary battery 118 is charged from the power grid 116 while not placing a high load on the power grid 116, thereby reducing the peak power drawn from the power grid 116.

At step 604, the stationary battery 118 is connected with the traction battery 102. For example, the switching unit 204 connects the stationary battery 118 with the traction battery 102. In an embodiment, the charging controller 120 receives a message from the control unit 110 indicative of a charging requirement of the traction battery 102. Based on the received message, the charging controller 120 may control the switching unit 204 to switch from the first closed circuit to the second closed circuit. Thus, the stationary battery 118 gets disconnected from the power grid 116, and establishes a connection with the traction battery 102, through the power connection unit 106, for charging the traction battery 102. The charging controller 120 may also control the switching unit 204 based on other parameters, such as, the remaining energy in the stationary battery 118 or an indication whether the power connection unit 106 is electrically connected to the charging system 200. For example, the charging controller 120 may only permit the connection of the stationary battery 118 to the traction battery 102 as long as the voltage or the remaining energy of the stationary battery 118 remains above a preset safe level. The charging controller 120 may thus advantageously prevent deep discharge of the stationary battery 118, and thus prolong the operational life of the stationary battery 118. It may be possible that the switching unit 204 alternates between the first closed circuit and the second closed circuit one or more times during a single halt of the locomotive 100 based on various parameters of the stationary battery 118.

At step 606, the stationary battery 118 charges the traction battery 102 at a second controlled rate using the second controlled power supply 206. The second controlled power supply 206 is configured to provide electrical energy from the stationary battery 118 to charge the traction battery 102 at a second controlled rate. The second controlled rate may be chosen such that the traction battery 102 is charged at a rapid rate over a short duration of time. Typically, the second controlled rate is higher than the first controlled rate. The second controlled rate may however still be chosen to not exceed a preset level, thereby preventing any damage to the stationary battery 118. The second controlled rate may also be advantageously chosen such that the traction battery 102 is charged at lower than a preset charging rate

In an embodiment, the second controlled power supply 206 charges the traction battery 102 at the third controlled rate simultaneously from the stationary battery 118, and the power grid 116. In an embodiment, the third controlled rate is greater than the first controlled rate. In various embodiments, the power grid 116 may be disconnected intermittently from the second closed circuit in order to reduce the peak power draw from the power grid 116, or to safeguard the various electrical components of the charging system 300 against electric surges.

The charging systems 200 and 300, and the method 600, as described above, may be used in conjunction with not only the locomotive 100, but also with other electric vehicles, for example, but not limited to, battery powered mining trucks, highway trucks, buses, passenger cars, buses or the like

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A charging system for a traction battery, the charging system comprising:
a power grid;
a stationary battery;
a first controlled power supply configured to provide electrical power from the power grid to the stationary battery;
a second controlled power supply configured to provide electrical power from the stationary battery to the traction battery; and
a switching unit configured to form one of:
a first closed circuit for charging the stationary battery, at a first controlled rate, through the power grid, wherein the first closed circuit comprises the stationary battery, the first controlled power supply, and the power grid; and
a second closed circuit for charging the traction battery, at a second controlled rate, from the stationary battery, wherein the second closed circuit comprises the stationary battery, the second controlled power supply, and the traction battery.

2. The charging system of claim 1, wherein the second controlled rate is greater than the first controlled rate.

3. The charging system of claim 1, wherein the second closed circuit further includes the power grid to charge the traction battery at a third controlled rate.

4. The charging system of claim 3, wherein the third controlled rate is greater than the first controlled rate.

5. The charging system of claim 1, wherein the first controlled power supply includes a power conversion unit and a first direct current power supply.

6. The charging system of claim 1, wherein the second controlled power supply includes at least one of a voltage converter, and a voltage regulator.

7. The charging system of claim 6, wherein the second controlled power supply further includes a second controlled rectifier and a second direct current power supply.

8. The charging system of claim 1 further includes a charging controller communicably coupled with the switching unit, wherein the charging controller is configured to issue a command to the switching unit for switching from the first closed circuit to the second closed circuit or from the second closed circuit to the first closed circuit.

9. A method for charging a traction battery, the method comprising:
charging a stationary battery at a first controlled rate from a power grid using a first controlled power supply;
connecting the stationary battery to the traction battery; and
charging the traction battery at a second controlled rate from the stationary battery using a second controlled power supply.

10. The method of claim 9 further comprises selectively disconnecting the stationary battery from the power grid.

11. The method of claim 9, wherein the second controlled rate is greater than the first controlled rate.

12. The method of claim 9, wherein charging the traction battery further includes charging the traction battery at a third controlled rate from the stationary battery and the power grid.

13. The method of claim 12, wherein the third controlled rate is greater than the first controlled rate.

14. The method of claim 9 further includes receiving a command from a charging controller to:
switch from a first closed circuit configured to charge the stationary battery from the power grid to a second closed circuit configured to charge the traction battery from the stationary battery; and
switch from the second closed circuit to the first closed circuit.

15. The method of claim 14, wherein the second closed circuit is further configured to charge the traction battery simultaneously from the stationary battery and the power grid.

16. A locomotive comprising:
a traction battery;
a power connection unit for coupling the traction battery to a charging station, wherein the charging station includes a power grid and a stationary battery; and
a control unit configured to:
monitor a remaining energy in the traction battery, and a location of the locomotive with respect to the charging station;
communicate a signal to the charging station to disconnect a first closed circuit, wherein the first closed circuit is configured to charge the stationary battery at a first controlled rate from the power grid, and wherein the signal is indicative of a charging requirement of the traction battery; and
actuate the power connection unit to engage the stationary battery to establish a second closed circuit, wherein the second closed circuit is configured to charge the traction battery at a second controlled rate from the stationary battery.

17. The locomotive of claim 16, wherein the second controlled rate is greater than the first controlled rate.

18. The locomotive of claim 16, wherein the second closed circuit is configured to charge the traction battery at a third controlled rate simultaneously from the stationary battery and the power grid.

19. The locomotive of claim 18, wherein the third controlled rate is greater than the first controlled rate.

20. The locomotive of claim 16, wherein the power connection unit includes a pantograph and a contact shoe.
